(19) United States
(12) Patent Application Publication
(10) Pub. No.: US 2020/0379731 A1
(43) Pub. Date: Dec. 3, 2020

(54) VOICE ASSISTANT

(71) Applicant: ORANGE, Paris (FR)

(72) Inventors: Julien Pairis, Chatillon Cedex (FR); David Wuilmot, Chatillon Cedex (FR)

(21) Appl. No.: 16/954,947

(22) PCT Filed: Dec. 7, 2018
(86) PCT No.: PCT/FR2018/053158

§ 371 Date: Jun. 17, 2020

(30) Foreign Application Priority Data
Dec. 18, 2017 (FR) 1762353

(51) Int. Cl. G06F 3/16; G06F 3/01; G10L 15/22

(52) U.S. Cl. CPC G06F 3/167; G10L 15/22; G06F 3/017

(57) ABSTRACT

An assistance device (1) comprising:
at least one processor (3) operatively coupled with a memory (5),
at least one first input (10) connected to the processor (3) and capable of receiving video data coming from at least one video sensor (11), and
at least one second input (20) connected to the processor (3) and capable of receiving audio data coming from at least one microphone (21).
The processor (3) is arranged for:
analyzing the video data coming from the first input (10),
identifying at least one reference human gesture in the video data, and
triggering an analysis of audio data only if said at least one reference human gesture is detected in the video data.

### CROSS-REFERENCE TO RELATED APPLICATIONS

This application is a U.S. national stage application of International Application No. PCT/FR2018/053158, filed Dec. 7, 2018, which claims priority to French Patent Application No. 1762353, filed Dec. 18, 2017, the entire contents of each of which are hereby incorporated by reference in their entirety and for all purposes.

### FIELD OF THE DISCLOSURE

The invention relates to the field of providing services, in particular by voice command.

### BACKGROUND

The growth of “connected” objects is tending to facilitate machine-machine interactions and compatibility between devices. For example, a mobile phone can be used as an interface to control a wireless speaker or a television set of another manufacturer/designer.

In addition, domestic devices, particularly in the multimedia and high-fidelity (“Hi-Fi”) fields, have human-machine interfaces whose nature is evolving. Voice-activated interfaces are tending to replace touch screens, which themselves have replaced remote controls with physical buttons. Such voice-activated interfaces are the basis of the growth of “voice assistants” such as the systems known as “Google Home” (Google), “Siri” (Apple), or “Alexa” (Amazon).

To avoid inadvertent triggering, voice assistants are generally intended to activate only when a keyword or a key phrase is spoken by the user. It is also theoretically possible to limit activation by recognizing only the voices of users assumed to be legitimate. However, such precautions are imperfect, particularly when the received sound quality does not permit good sound analysis, for example in a noisy environment. The keyword or key phrase may not be picked up by the microphone or may not be recognized among all the captured sounds. In such cases, triggering is impossible or erratic.

The invention improves the situation.

### SUMMARY OF THE DISCLOSURE

An assistance device is proposed, comprising:
at least one processor operatively coupled with a memory,
at least one first input connected to the processor and capable of receiving video data coming from at least one video sensor, and
at least one second input connected to the processor and capable of receiving audio data coming from at least one microphone,

the processor being arranged for:
analyzing the video data coming from the first input,
identifying at least one reference human gesture in the video data, and
triggering an analysis of audio data only if said at least one reference human gesture is detected in the video data.

According to another aspect, an assistance system is proposed comprising such a device and at least one of the following members:
a video sensor connected or connectable to the first input;
a microphone connected or connectable to the second input;
a loudspeaker connected or connectable to an output of the device.

According to another aspect, an assistance method implemented by computer means is proposed, comprising:
analyzing video data coming from a first input,
identifying at least one reference human gesture in the video data, and
triggering an analysis of audio data only if said at least one reference human gesture is detected in the video data.

According to another aspect of the invention, a computer program is proposed comprising instructions for implementing the method as defined herein when the program is executed by a processor. According to another aspect of the invention, a non-transitory computer-readable storage medium is proposed on which such a program is stored.

Such objects allow a user to trigger the implementation of a voice command process by making a gesture, for example with the hand. Untimely triggering and a lack of triggering usually resulting from a failure in the speech recognition process are thus avoided. In particular, the triggering of the voice command process is impervious to ambient noise and unintentional voice commands. Gesture-controlled interfaces are less common than voice-controlled interfaces, especially since it is considered less natural or less instinctive to address a machine by gestures than by voice. Consequently, the use of gestural commands is reserved for specific contexts rather than for “general public” and “household” uses. Such objects are particularly advantageous when combined with voice assistants. Gesture recognition to trigger speech recognition can be combined with triggering by speech recognition (speaking keyword(s)). In this case, the user can choose either to make a gesture or to say one or more words to activate the voice assistant. Alternatively, triggering by gesture recognition replaces triggering by speech recognition. In this case, the effectiveness is further improved. This also makes it possible to neutralize the microphones outside assistant activation periods, either by switching them off or by disconnecting them. The risks of microphones being used for unintended purposes, for example by a third party usurping control of such voice assistants, are reduced.

The following features may optionally be implemented. They may be implemented independently of one another or in combination with one another:
The device may further comprise an output controlled by the processor and capable of transmitting commands to a sound system. Furthermore, the processor may be arranged to transmit a command to reduce the sound volume or to stop the emission of sound in the event of said at least one reference human gesture being detected in the video data. This makes it possible to reduce the ambient noise and therefore to facilitate subsequent audio analysis operations, particularly speech recognition, and therefore improves the relevance and operability of services based on audio analysis.
The analysis of audio data may include a recognition of voice commands. This makes it possible to provide the user with interactive services, particularly voice assistance types of services.
The device may further comprise an output controlled by the processor and capable of transmitting commands to a third-party device. The processor may be further arranged to transmit a command on said output, the command being selected according to the results of the recognition of voice commands. Such a device allows voice control of third party devices in an improved manner.
The processor may further be arranged to trigger the emission of a visual and/or audio indicator perceptible by a user in the event of the detection of said at least one reference human gesture in the video data. This allows the user to speak words/phrases intended for certain devices only when he or she knows that the audio analysis is in effect, which prevents the user from having to repeat certain commands unnecessarily.
The triggering of the emission of an indicator can include:
   turning on an indicator light of the device,
   emitting a predetermined sound on an output of the device, and/or
   emitting a predetermined word or a predetermined series of words on an output of the device.

This makes it possible to adapt to many situations, particularly when the environment is noisy or when an indicator light is not visible to a user.

The above optional features can be transposed, independently of one another or in combination with one another, to non-transitory computer-readable devices, systems, methods, computer programs, and/or storage media.

### BRIEF DESCRIPTION OF THE DRAWINGS

Other features, details, and advantages will be apparent from reading the detailed description below, and from an analysis of the appended drawings in which:

FIG. 1 shows a non-limiting example of a proposed device according to one or more embodiments, and

FIG. 2 shows a non-limiting example of interactions implemented according to one or more embodiments.

### DETAILED DESCRIPTION

In the following detailed description of some embodiments, many specific details are presented for the purpose of achieving a more complete understanding. Nevertheless, a person skilled in the art will realize that some embodiments can be implemented without these specific details. In other cases, well-known features are not described in detail, to avoid unnecessarily complicating the description.

In the following, the detection of at least one human gesture is involved. The term “gesture” is used here in its broad sense, namely as concerning movements (dynamic) as well as positions (static) of at least one member of the human body, typically a hand.

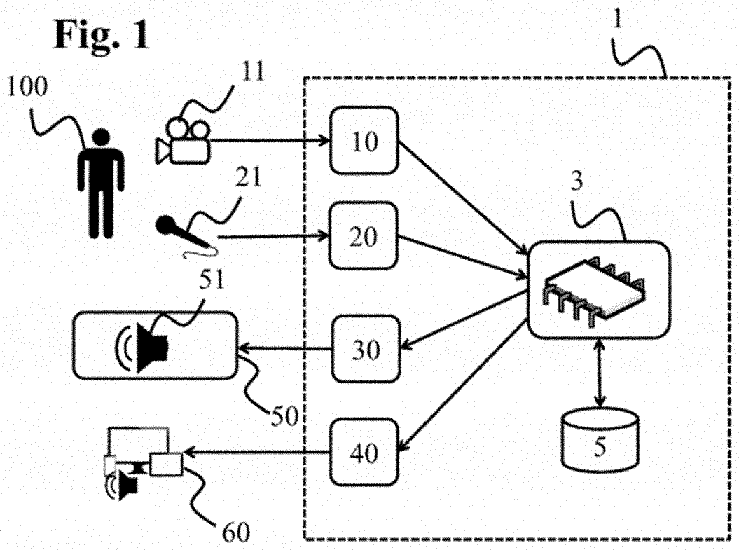

FIG. 1 represents an assistance device 1 available to a user 100. The device 1 comprises:
at least one processor 3 operatively coupled with a memory 5,
at least one first input 10 connected to the processor 3, and
at least one second input 20 connected to the processor 3.

The first input 10 is capable of receiving video data coming from at least one video sensor 11, for example a camera or webcam. The first input 10 forms an interface between the video sensor and the device 1 and is in the form, for example, of an HDMI (“High-Definition Multimedia Interface”) connector. Alternatively, other types of video input may be provided in addition to or in place of the HDMI connector. For example, the device 1 may comprise a plurality of first inputs 10, in the form of several connectors of the same type or of different types. The processor 3 can thus receive several video streams as input. This allows, for example, capturing images in different rooms of a building or from different angles. The device 1 may also be made compatible with a variety of video sensors 11.

The second input 20 is capable of receiving audio data coming from at least one microphone 21. The second input 20 forms an interface between the microphone and the device 1 and is, for example, in the form of a coaxial type of connector (for example called a jack). As a variant, other types of audio input may be provided, in addition to or in replacement of the coaxial connector. In particular, the first input 10 and the second input 20 may have a common connector, capable of receiving both a video stream and an audio stream. HDMI connectors for example are connectors with this possibility. HDMI connectors also have the advantage of being widespread in existing devices, notably television sets. A single HDMI connector can thus enable the device 1 to be connected to a television set equipped with both a microphone and a camera. Such third-party equipment can then be used to supply respectively a first input 10 and a second input 20 of the device 1.

For example, the device 1 may also comprise a plurality of second inputs 20, in the form of several connectors of the same type or of different types. The processor 3 can thus receive several audio streams as input, for example from several microphones distributed within a room, which makes it possible to improve the subsequent speech recognition by signal processing methods that are known per se. The device 1 may also be made compatible with a variety of microphones 21.

In the non-limiting example shown in FIG. 1, the device 1 further comprises:
an output 30 connected to the processor 3 and controlled by the processor 3.

Output 30 is capable of transmitting commands to a sound system 50, for example a connected speaker system, a high-fidelity system (“Hi-Fi”), a television set, a smart phone, a tablet, or a computer. The sound system 50 comprises at least one loudspeaker 51.

In the non-limiting example shown in FIG. 1, the device 1 further comprises:
an output 40 connected to the processor 3 and controlled by the processor 3.

Output 40 is capable of transmitting commands to at least one third party device 60, for example a connected speaker system, a Hi-Fi system, a television set, a smart phone, a tablet, or a computer.

The outputs 30, 40 may, for example, be in the form of connectors of various types preferably selected to be compatible with third-party equipment. The connector of one of the outputs 30, 40 may, for example, be shared with the connector of one of the inputs. For example, HDMI connectors allow the implementation of two-way audio transmissions (technology known by the acronym “ARC” for “Audio Return Charnel”). A second input 20 and an output 30 can thus have a shared connector connected to an equipment item such as a television, including both a microphone 21 and loudspeakers 51.

For example, the device 1 may also comprise a single output or more than two outputs in the form of several connectors of the same type or of different types. The processor 3 can thus output several commands, for example to control several third-party devices separately.

Up to this point, the inputs 10, 20 and outputs 30, 40 have been presented as being in the form of one or more mechanical connectors. In other words, the device 1 can be connected to third-party equipment by cables. As a variant, at least some of the inputs/outputs may be in the form of a wireless communication module. In such cases, the device 1 also comprises at least one wireless communication module, so that the device 1 can be wirelessly connected to remote third-party devices, including devices as presented in the above example. The wireless communication modules are then connected to the processor 3 and controlled by the processor 3.

The communication modules may, for example, include a short-distance communication module, for example based on radio waves such as WiFi. Wireless local area networks, particularly household networks, are often implemented using a WiFi network. The device 1 can thus be integrated into an existing environment, in particular into what are called “home automation” networks.

The communication modules may, for example, include a short-distance communication module, for example of the Bluetooth® type. A large portion of recent devices are equipped with communication means compatible with Bluetooth® technology, particularly smart phones and so-called “portable” speaker systems.

The communication modules may, for example, include a module for near field communication (or NFC). In such cases, as the communication is only effective at distances of a few centimeters, the device 1 must be placed in the immediate vicinity of relays or of third-party equipment to which connection is desired.

In the non-limiting example represented in FIG. 1, the video sensor 11, the microphone 21, and the loudspeaker 51 of the sound system 50 are third-party equipment items (not integrated into the device 1). These equipment items can be connected to the processor 3 of the device 1 while being integrated into other devices, together or separately from one another. Such third-party devices comprise, for example, a television, a smart phone, a tablet, or a computer. These equipment items can also be connected to the processor 3 of the device 1 while being independent of any other device. In the embodiments in which at least some of the aforementioned equipment items are absent from the device 1, in particular the video sensor 11 and the microphone 21, the device 1 can be considered a multimedia console, or support device, intended to be connected or paired with at least one third-party device, for example a television set. In this case, such a multimedia console is only operational once it is connected to such a third-party device. Such a multimedia console may be included within a TV set top box (designated by the acronym STB) or even within a gaming console.

Alternatively, at least some of the aforementioned equipment items may be integrated into the device 1. In this case, the device 1 further comprises:
at least one video sensor 11 connected to a first input 10;
at least one microphone 21 connected to a second input 20; and/or
at least one loudspeaker 51 connected to an output 30 of the device 1.

Alternatively, the device 1 comprises a combination of integrated equipment items and inputs/outputs intended to connect to third-party devices and devoid of any corresponding integrated equipment items.

In some variants, the device 1 further comprises at least one visual indicator, for example one or more indicator lights. Such an indicator, controlled by the processor 3, can be activated to inform the user 100 about a state of the device 1. The state of such an indicator may vary, for example during pairing operations with third-party equipment and/or in the event of activation or deactivation of the device 1 as will be described in more detail below.

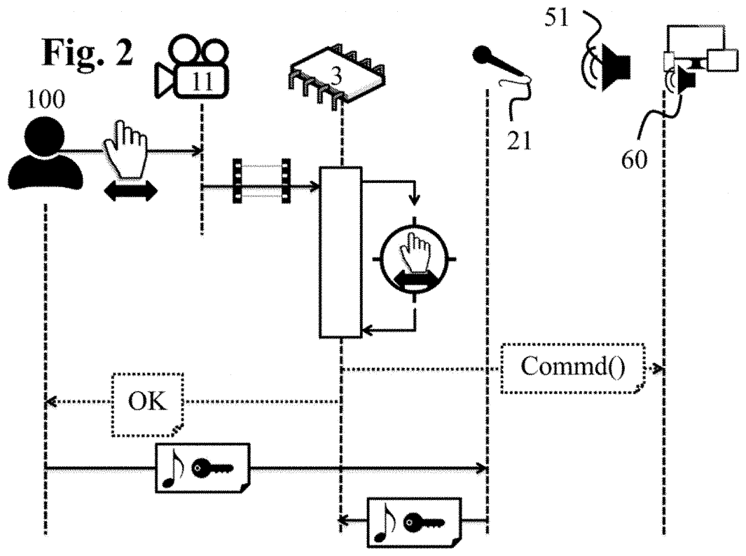

In the embodiments for which at least some of the aforementioned equipment items are integrated into the device 1, in particular at least one video sensor 11 and at least one microphone 21, the device 1 can be considered a device that is at least partially autonomous. In particular, the method described below and with reference to FIG. 2 can be implemented by the device 1 without it being necessary to connect it or to pair it with third-party devices.

The device 1 further comprises a power source, not shown, for example a power cord for connection to the power grid and/or a battery.

In the examples described here, the device 1 comprises a single processor 3. Alternatively, several processors can cooperate to implement the operations described herein.

The processor 3, or data processing unit (CPU), is associated with the memory 5. The memory 5 comprises for example random access memory (RAM), read-only memory (ROM), cache memory, and/or flash memory, or any other storage medium capable of storing software code in the form of instructions executable by a processor or data structures accessible by a processor.

The processor 3 is arranged for:
analyzing the video data coming from at least one first input 10,
identifying at least one reference human gesture in the video data, and
triggering an analysis of audio data only if said at least one reference human gesture is detected in the video data.

The reference gesture or reference gestures may be, for example, stored in the form of determination/identification criteria in the memory 5 and which the processor 3 calls upon during the analysis of the video data. Such criteria may be set by default. Alternatively, such criteria may be modified by software updates and/or by learning from the user 100. The user 100 can thus select the key gestures or reference gestures which enable triggering the analysis of the audio data.

In the examples described here, both the triggering of the audio data analysis and the audio analysis itself are implemented by the device 1 (by means of a second input 20 and the processor 3). Alternatively, the triggering is implemented by the device 1 while the audio analysis is implemented by a third-party device to which the device 1 is connected. In other words, the device 1 may operate in what is called “autonomous” mode in the sense that the device 1 itself performs the audio analysis and optionally some subsequent operations. Such a device 1 can advantageously replace a voice assistant. The device 1 may also operate in “support” mode in the sense that the device 1 triggers audio analysis by a third-party device, for example by transmitting an activation signal to the third-party device, such as those labeled 60 and connected to output 40.

In other words, the processor 3 may optionally be arranged to implement the analysis of the audio data in addition to the triggering.

Whether the device 1 operates in “autonomous” or “support” mode, the triggering of the audio analysis by detection of a gesture can be combined with voice triggering of the audio analysis (speaking one or more keywords). Thus, the audio analysis and the services which result from it can remain activatable, in parallel, by voice alone independently of gestures (detected by a third-party device), as well as by gestures independently of voice (detected by the device 1). The triggering may also be dependent upon detection of a combination of voice and the use of a reference gesture, simultaneously or successively.

Alternatively, the triggering of audio analysis by detection of a gesture may be exclusive of the triggering of audio analysis by voice. In other words, the device 1 may be arranged so that voice, including the voice of the user 100, is rendered inoperative prior to triggering the audio analysis by gesture. Thus, a device 1 in autonomous mode, or a system combining a support device 1 with a third-party device, can prohibit any voice triggering of audio analysis.

The analysis of audio data may include recognition of voice commands. Techniques for the recognition of voice commands are known per se, in particular in the context of voice assistants.

FIG. 2 represents the interactions between different elements during the implementation of a method according to one embodiment.

The user 100 performs a gesture (static or dynamic). The gesture is captured by a video sensor 11 connected to a first output 10 of a device 1. The processor 3 of the device 1 receives a video stream (or video data) including the capture of the reference gesture. The processor 3 may receive a substantially continuous video stream, or for example only when a movement is detected.

The processor 3 implements an operation of analyzing the video data received. The operations include attempts to identify one or more reference human gestures. If no reference gesture is detected, then the rest of the method is not triggered. Device 1 remains on standby.

If the reference gesture made by the user 100 is detected, then the rest of the method is implemented. In FIG. 2, the implementation of two optional operations that are independent of one another are represented with dashed lines:
an operation aimed at reducing ambient noise before implementing the audio analysis, and
an operation aimed at confirming to the user 100 that audio analysis has been or is about to be triggered.

In embodiments comprising a combination of these two optional operations, they may be implemented one after the other or concomitantly.

In some embodiments, the processor 3 is therefore further arranged to transmit a command to reduce the sound volume or to stop the emission of sound in the event of at least one reference human gesture being detected in the video data. The command is, for example, transmitted via output 30 and towards the sound system 50 including a loudspeaker 51 as is represented in FIG. 2. Additionally or alternatively, the transmission of such a command may be carried out via other outputs of the device 1 such as output 40 and towards third-party equipment items 60.

Furthermore, the processor 3 is arranged to trigger the emission of a visual and/or audio indicator perceptible by the user 100 in the event of the detection of at least one reference human gesture in the video data. The sending of the indicator is represented by the sending of an “OK” in FIG. 2. For example, triggering the emission of an indicator may include:
turning on an indicator light of the device 1;
emitting a predetermined sound on an output of the device 1, for example outputs 30 and/or 40 of the embodiment of FIG. 1; and/or
emitting a predetermined word or a predetermined series of words on an output of the device 1, for example outputs 30 and/or 40 of the embodiment of FIG. 1.

In the embodiment shown in FIG. 2, once the analysis of the audio data has started, the processor 3 is arranged to receive audio data to be analyzed, in particular via a second output 20 and the microphone 21. The audio data comprise, for example, a voice command spoken by the user 100. In some non-limiting examples, the processor 3 may further be arranged to implement an audio analysis including recognition of voice commands, then to transmit a command selected according to the results of the recognition of voice commands, in particular via outputs 30 and/or 40, and intended respectively for the sound system 50 and/or a third-party device 60.

The variety of voice commands that can be translated by the device 1 into commands that can be interpreted electronically by third-party devices comprises, for example, the usual commands of a Hi-Fi system such as “increase the volume”, “decrease the volume”, “change track”, or “change the source”.

Up to this point, reference has been made to embodiments and variants of a device 1. A person skilled in the art will easily understand that the various combinations of operations described as implemented by the processor 3 can generally be understood as forming a method for assistance (of the user 100) implemented by computer means. Such a method may also take the form of a computer program or of a medium on which such a program is stored.

The device 1 has been presented in an operable state. A person skilled in the art will further understand that, in practice, the device 1 can be in a temporarily inactive form, such as a system including various parts intended to cooperate with each other. Such a system may, for example, comprise a device 1 and at least one among a video sensor connectable to the first input 10, a microphone connectable to the second input 20, and a loudspeaker 51 connectable to an output 30 of the device 1.

Optionally, the device 1 may be provided with a processing device including an operating system and programs, components, modules, and/or applications in the form of software executed by the processor 3, which can be stored in non-volatile memory such as memory 5.

Depending on the embodiments chosen, certain acts, actions, events, or functions of each of the methods and processes described in this document may be carried out or take place in a different order from that described, or may be added, merged, or omitted or not take place, depending on the case. In addition, in certain embodiments, certain acts, actions, or events are carried out or take place concurrently and not successively or vice versa.

Although described via a certain number of detailed exemplary embodiments, the proposed methods and the systems and devices for implementing the methods include various variants, modifications, and improvements which will be clearly apparent to the skilled person, it being understood that these various variants, modifications, and improvements are within the scope of the invention, as defined by the protection being sought. In addition, various features and aspects described above may be implemented together, or separately, or substituted for one another, and all of the various combinations and sub-combinations of the features and aspects are within the scope of the invention. In addition, certain systems and equipment described above may not incorporate all of the modules and functions described for the preferred embodiments.

The invention is not limited to the exemplary devices, systems, methods, storage media, and programs described above solely by way of example, but encompasses all variants that the skilled person can envisage within the protection being sought.

1. An assistance device comprising:
at least one processor operatively coupled with a memory,
at least one first input connected to the processor and capable of receiving video data coming from at least one video sensor, and
at least one second input connected to the processor and capable of receiving audio data coming from at least one microphone,
the processor configured to:
analyze the video data coming from the first input,
identify at least one reference human gesture in the video data, and
trigger an analysis of audio data only if said at least one reference human gesture is detected in the video data.

2. The device according to claim 1, further comprising an output controlled by the processor and capable of transmitting commands to a sound system, the processor further configured to transmit a command to reduce the sound volume or to stop the emission of sound in the event of said at least one reference human gesture being detected in the video data.

3. The device according to claim 1, wherein the analysis of audio data includes a recognition of voice commands.

4. The device according to claim 3, further comprising an output controlled by the processor and capable of transmitting commands to a third-party device, the processor further configured to transmit a command on said output, the command selected according to the results of the recognition of voice commands.

5. The device according to claim 1, wherein the processor is further configured to trigger the emission of a visual and/or audio indicator perceptible by a user in the event of the detection of said at least one reference human gesture in the video data.

6. The device according to claim 5, wherein the triggering of the emission of an indicator includes:
turning on an indicator light of the device,
emitting a predetermined sound on an output of the device, and/or
emitting a predetermined word or a predetermined series of words on an output of the device.

7. An assistance system comprising a device according to claim 1 and at least one of the following members:
a video sensor connected or connectable to the first input;
a microphone connected or connectable to the second input;
a loudspeaker connected or connectable to an output of the device.

8. An assistance method, implemented by a computer device, the method comprising:
analyzing video data coming from a first input,
identifying at least one reference human gesture in the video data, and
triggering an analysis of audio data only if said at least one reference human gesture is detected in the video data.

9. A non-transitory computer-readable storage medium on which is stored a program comprising instructions for implementing the method according to claim 8.

10. A computer program comprising instructions for implementing the method according to claim 8 when this program is executed by a processor.
